(19) United States
(12) Patent Application Publication
(10) Pub. No.: US 2008/0173410 A1
(43) Pub. Date: Jul. 24, 2008

(54) Slat structure for vertical window shades

(76) Inventor: A-Nan Chen, Luh-Gaang Chen (TW)

Correspondence Address: BRUCE H. TROXELL;SUITE 1404, 5205 LEESBURG PIKE, FALLS CHURCH, VA, 22041, US

(21) Appl. No.: 11/657,124

(22) Filed: Jan. 24, 2007

(51) Int. Cl. E06B 9/00

(52) U.S. Cl. 160/236

(57) ABSTRACT

A slat structure for vertical window shades to enhance ornamental effect includes a clipping member, a slat body, a covering ornamental fabric and a loading member. The covering ornamental fabric has a plurality of strip bands to cover at least one lateral side of the slat to provide a three-dimensional layer appearance. Thus it offers more aesthetic appeal and can be trimmed at a desired length according to requirements, thereby increases the value when in use.

### BACKGROUND OF THE INVENTION

1. Field of the Invention

The present invention relates to a slat structure for window shades and particularly to a slat for vertical shades that has a layer structure to provide three dimensional effect and can be trimmed by users according to requirements to enhance value when in use.

2. Description of the Prior Art

Refer to FIG. 1 for a widely used conventional slat for vertical window shades. The slat 11 has a upper end stitched to form a first sleeve 112 to hold a clipping plate 111 and a lower end stitched to form a second sleeve 114 to hold a loading plate 113. A plurality of the slats 11 can be assembled to form a complete vertical window shade. Such a structure looks plain and does not have much color or aesthetic appeal. To remedy this drawback another conventional slat 12 has been introduced as shown in FIG. 2. It has a slat body 121 made from plastics with two clipping grooves 123 on two sides to be wedged in by an inside slat 122 of a different color. The slat 12 thus constructed has two different colors on the front and back sides.

However, the conventional slats mentioned above still have shortcomings, notably:
1. The first and second sleeves 112 and 114 have to be formed by stitching, thus are not convenient in production. Moreover, stitching the first and second sleeves 112 and 114 has to be made according to the length of user's window and has to be custom-made. It takes more time and the cost is higher.
2. The conventional slats are formed in a single style in one color, and do not have three-dimensional and layer structure, ornamental effect is not desirable and the added value is lower.

### SUMMARY OF THE INVENTION

In view of the aforesaid problems, the present invention aims to provide a slat structure for vertical window shade that has a layer structure to provide three-dimensional aesthetic appeal, and allows users to trim at a desired length according to requirements to enhance the value when in use.

The slat structure of the invention includes a clipping member, a slat body, a covering ornamental fabric and a loading member. The covering ornamental fabric has a plurality of strip bands to cover at least one lateral side of the slat body. Thus a layer and three-dimensional effect can be achieved. Such a structure can enhance aesthetic appeal and be trimmed by users at a desired length according to requirements. The added value is much higher.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a conventional slat for a vertical window shade.

FIG. 2 is a cross section of another conventional slat for a vertical window shade.

FIG. 3 is an exploded view of the slat of the invention.

FIG. 4 is a sectional view of the invention.

FIG. 5 is a schematic view of an embodiment of the invention.

FIG. 6 is a schematic view of a first embodiment of a coupling member of the invention.

FIG. 7 is a schematic view of a second embodiment of a coupling member of the invention.

FIG. 8 is a schematic view of a third embodiment of a coupling member of the invention.

FIG. 9 is a schematic view of a fourth embodiment of a coupling member of the invention.

FIG. 10 is a schematic view of a fifth embodiment of a coupling member of the invention.

FIG. 11 is a schematic view of an embodiment of a loading member of the invention.

FIG. 12 is a sectional view of an embodiment of a loading member of the invention.

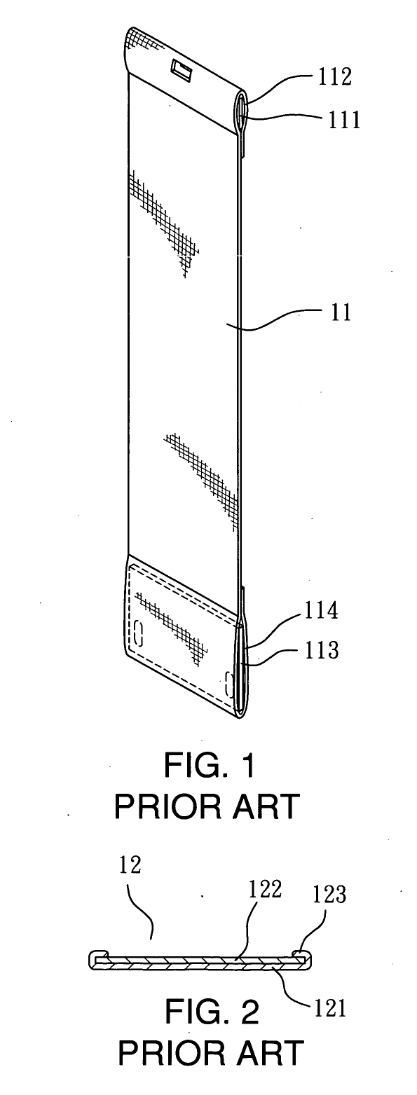

### DESCRIPTION OF THE PREFERRED EMBODIMENTS

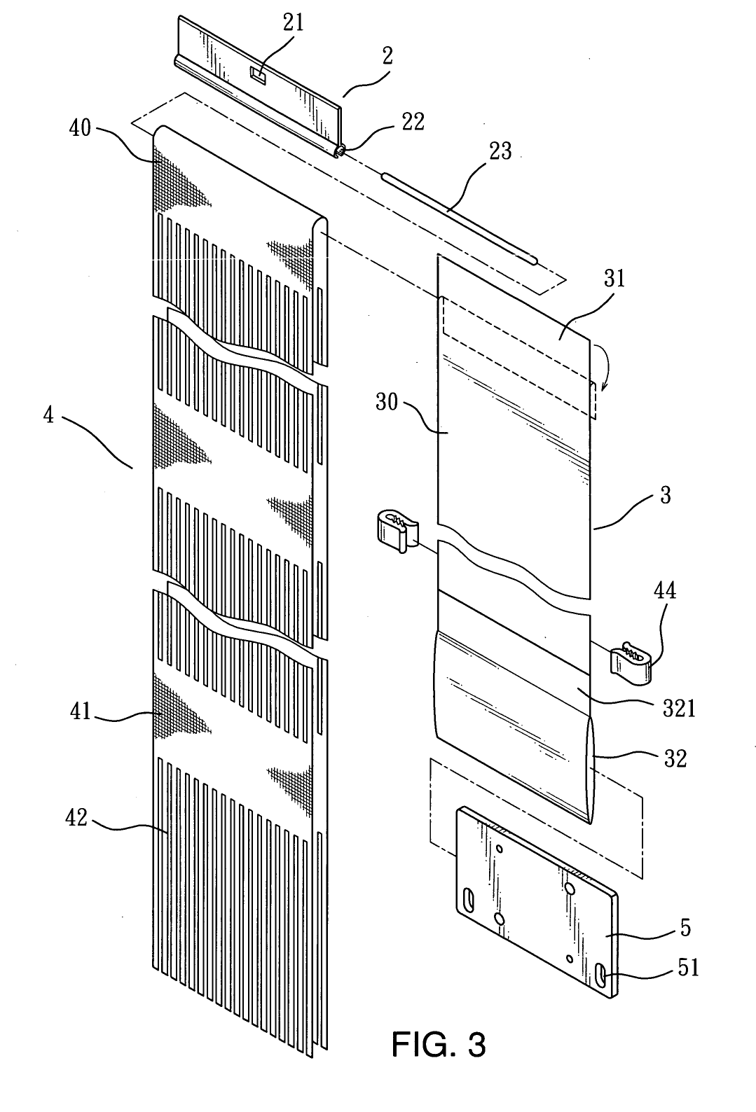

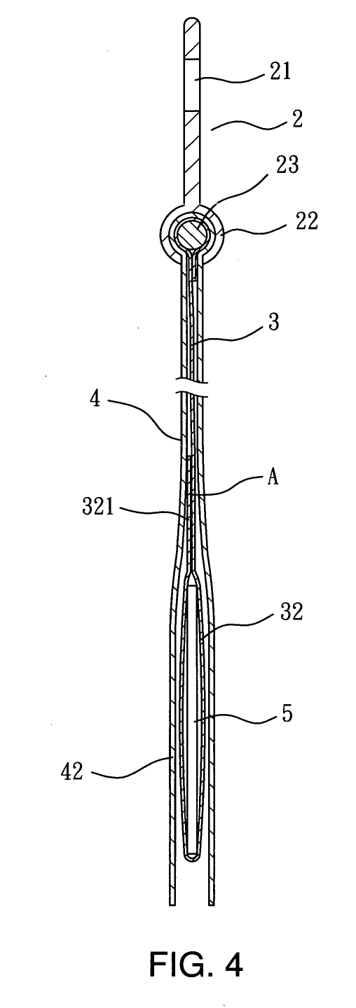

Referring to FIGS. 3, 4 and 5, the slat structure according to the invention includes a clipping member 2, a slat body 3, a covering ornamental fabric 4 and a loading member 5.

The clipping member 2 aims to clip a first end 31 of the slat body 3 and a clipping portion 40 of the ornamental fabric 4. It has a hanging aperture 21 on a upper edge and a clipping groove 22 on a lower edge to hold the first end 31 of the slat body 3 and the clipping portion 40 of the ornamental fabric 4, and is wedged in by an insertion strip 23 for anchoring.

The slat body 3 is an elongate panel and has a second end 321 to couple with the loading member 5. It is bent upwards and has an adhesive layer A on an inner side and a coupling hole 32 on a lower side.

The covering ornamental fabric 4 is a woven fabric formed at a width approximate the slat body 3 to cover at least one lateral side 30 of the slat body 3. It includes a plurality of solid fabric zones 41 and a plurality of strip bands 42 that are spaced from one another alternately. It is anchored on the slat body 3 through a coupling member 44. The solid fabric zones 41 may have a decorative and colored graphics formed thereon.

The loading member 5 is held in the coupling hole 32 of the second end 321 of the slat body 3.

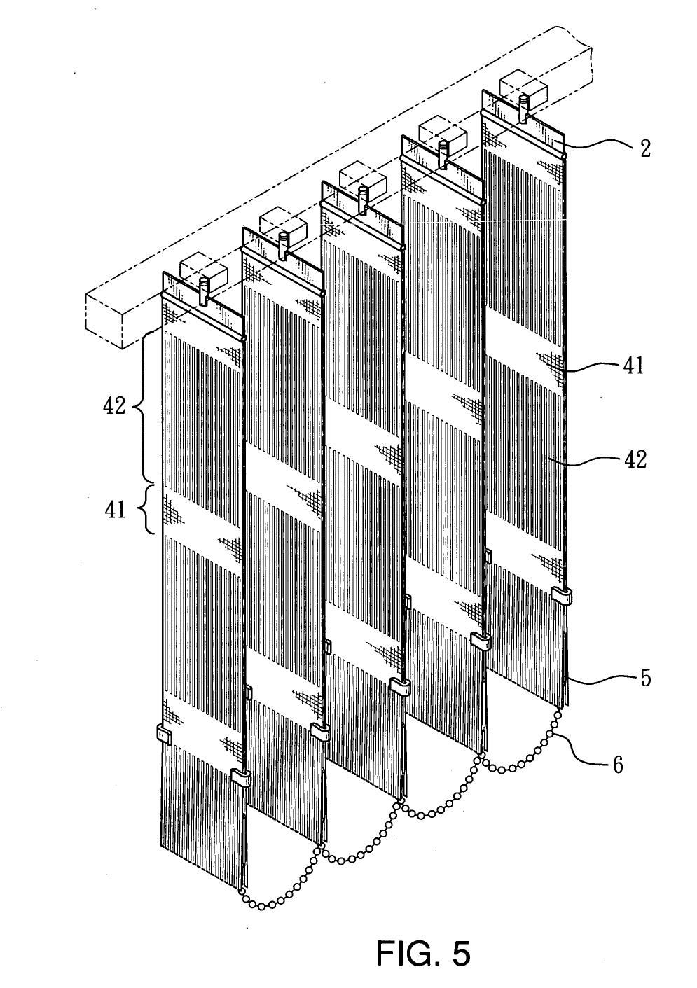

For assembly, dispose the first end 31 of the slat body 3 and the clipping portion 40 of the covering ornamental fabric 4 in the clipping groove 22 of the clipping member 2, and wedge in the insertion strip 23 to form anchoring. The covering ornamental fabric 4 is pendent and covers at least one lateral side 30 of the slat body 3. Users can trim the length of the slat body 3 and the covering ornamental fabric 4 according to the length of the window. After trimmed, the second end 321 of the slat body 3 is bent upwards to form the coupling hole 32 by bonding the adhesive layer A. Then dispose the loading member 5 in the coupling hole 32, and coupling a chain-bead 6 in a side opening 51 of the loading member 5 to finish the assembly of a vertical window shade (referring to FIG. 5). The invention provides a three-dimensional layer structure, thus has more aesthetic appeal. It also can be trimmed by users according to the required length of the vertical window shade.

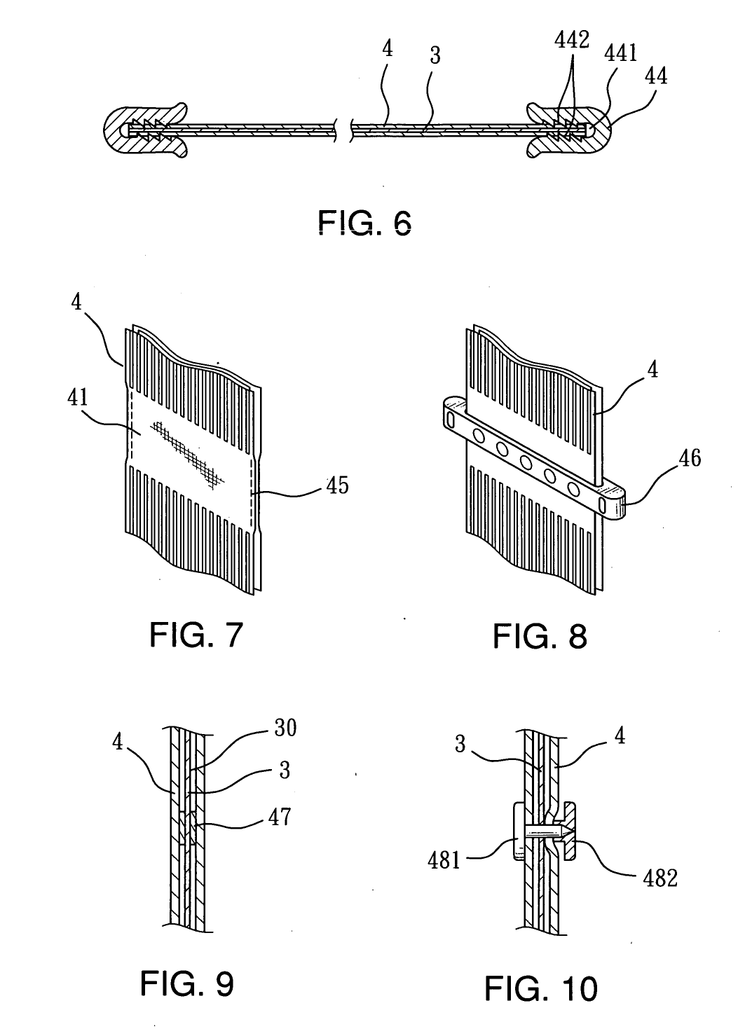

In order to prevent the covering ornamental fabric 4 from swaying or flying away, the coupling member 44 is provided at the solid fabric zone 41 to anchor the covering ornamental fabric 4 on the slat body 3. The coupling member 4 has a clipping notch 441 with a gear rack 442 on each of two inner sides to engage the covering ornamental fabric 4 with the slat body 3 for anchoring (referring to FIG. 6).

The coupling member may also be a stitching line 45 formed on one side of the covering ornamental fabric 4 and the solid fabric zone 41 (referring to FIG. 7) to achieve the anchoring effect.

The coupling member may further be an anchor ring 46 surrounding the solid fabric zone 41 (referring to FIG. 8) to achieve the anchoring effect.

The coupling member may further be a double-sided adhesive tape 47 located on an inner side of the solid fabric zone 41 to be bonded to the lateral side 30 of the slat body 3 (referring to FIG. 9).

The coupling member may further be an assembly consisting of a male latch 481 and a female latch 482 to couple the solid fabric zone 41 on an outer side of the slat body 3 (referring to FIG. 10).

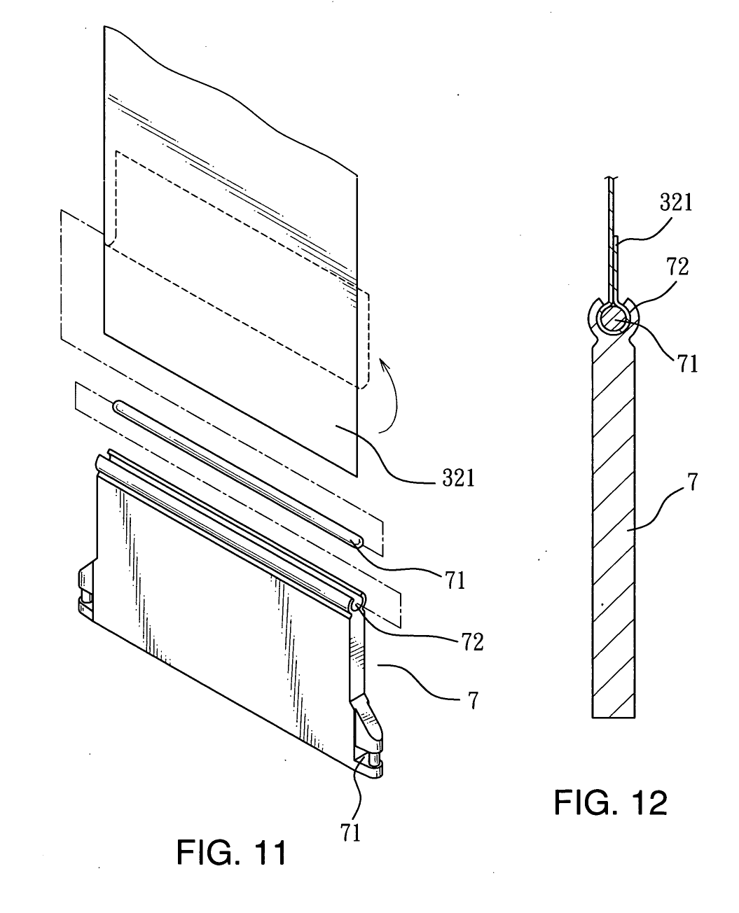

The loading member of the invention may include a balance weight 7 which has a clipping trough 72 on a upper edge to be wedged in by another insertion strip 71 to clip the second end 321 of the slat body 3 for anchoring (referring to FIGS. 11 and 12).

In short, the invention can be trimmed by users at a desired length in response to different requirements to quickly fit a window. It also provides a three-dimensional layer structure and has more aesthetic appeal. It offers a significant improvement over the conventional techniques.

I claim:

1. A slat structure for vertical window shades comprising a clipping member, a slat body, a covering ornamental fabric and a loading member, wherein:
the clipping member clips a first end of the slat body and a clipping portion of the covering ornamental fabric;
the slat body is an elongate panel and has a second end coupling with the loading member;
the covering ornamental fabric covers at least one lateral side of the slat body and has a plurality of solid fabric zones and a plurality of strip bands that are spaced from one another alternately, and is anchored on the slat body through a coupling member;
the loading member couples with the second end of the slat body.

2. The slat structure for vertical window shades of claim 1, wherein the coupling member has a clipping notch.

3. The slat structure for vertical window shades of claim 1, wherein the coupling member is a stitching line formed on two sides of the solid fabric zone.

4. The slat structure for vertical window shades of claim 1, wherein the coupling member is an anchor ring.

5. The slat structure for vertical window shades of claim 1, wherein the coupling member is a double-sided adhesive tape.

6. The slat structure for vertical window shades of claim 1, wherein the coupling member is an assembly consisting of a male latch and a female latch.

7. The slat structure for vertical window shades of claim 1, wherein the loading member has a clipping trough on a upper edge to be wedged in by an insertion strip to anchor the second end of the slat body.
